(19) United States
(12) Patent Application Publication
(10) Pub. No.: US 2012/0038922 A1
(43) Pub. Date: Feb. 16, 2012

(54) METHOD AND DEVICE FOR MEASURING AT LEAST ONE OF LIGHT INTENSITY AND COLOUR IN AT LEAST ONE MODULATED IMAGE

(75) Inventor: Knut Krogstad, Hvalstad (NO)

(73) Assignee: 3D PERCEPTION AS, Asker (NO)

(21) Appl. No.: 13/202,314

(22) PCT Filed: Feb. 18, 2010
(86) PCT No.: PCT/NO10/00063

§ 371 Date: Nov. 1, 2011

(30) Foreign Application Priority Data
Feb. 19, 2009 (NO) 2009 0791

(51) Int. Cl. G01J 3/46; G01J 1/42

(52) U.S. Cl. 356/402; 356/218

(57) ABSTRACT

It relates to a method for measuring at least one of light intensity and colour in at least one modulated image, the method comprising the steps of: a) detecting a modulation pattern of the modulated image(s); and b) synchronizing a measurement of the intensity and/or colour with the detected modulation pattern. It also relates to a corresponding device.

The present invention is related to a method and device for measuring at least one of light intensity and colour in at least one modulated image, and more precisely it is related to increasing quality and reducing expenditure of time in connection with the measurement of light and/or colours in a digital image projection system. The present method and device may for instance be used in sensor-based calibration when displaying or projecting images.

3D Perception supplies projectors and image processing units based on patented technology for geometry correction and edge blending between a plurality of projectors. In this connection, reference is made, inter alia, to Norwegian Patent 310490, and the corresponding rights in other countries. Reference is also made to, inter alia, U.S. Pat. Nos. 4,974,073, 5,136,390 and 6,115,022 which are related to edge blending, i.e., adjusting the edge areas between images projected from adjacent projectors that project images towards a common screen, whether such projection is only partly overlapping or fully overlapping.

In connection with the installation and maintenance of such systems there will be a need for calibration of colours in order to obtain optimum image quality. Today's digital projectors have variations in colour reproduction as a result of production variations in optics, light sources and image-forming electronics. Design and production deviations will also result in variations in colour and intensity across the image field. Typically, a projector will provide an apparently lighter image close to the centre of the image field. In addition, a projector in the course of its service life, and in particular in the course of the lifetime of the light source (“the light bulb”), will change characteristics in the form of light yield and colour temperature. Such projectors, as a rule, create colour through use of a rotating colour wheel for modulation of the light source.

The said image processing methods and said operational problems are also relevant in the case of other types of digital image display devices such as LCD (liquid crystal display), CRT (cathode ray tube) or laser-based screens and projectors. When reference is made to projector or projectors hereinbelow, it should be understood that the term also may refer to other types of display device equipment.

Today's projection technologies comprise, inter alia, the use of LCD, CRT, DLP (digital light processing), and/or laser-based projectors, and there may also be other ways of producing an image.

Known technologies permit the generation of colours by additive mixing of the primary colours red, green and blue, and in recent years colours such as cyanide blue, magenta red and yellow have been used to improve reproduction of colours that are to be produced by means of the projectors. Some projector technologies also use a white “colour” to increase light intensity in white areas of the images.

Shades of colour are produced by means of different mixing ratios between primary colours. A common feature of several of the known technologies is that the colour shades are produced by time variable modulation of the primary components, typically through pulse width modulation. Modulation is effected at a frequency that is sufficiently high to ensure that the human eye barely perceives the modulation, but instead perceives continuous light and colour.

Other display technologies (CRT and photographic film projector), for other reasons, emit modulated light: CRT in that an electron beam at regular intervals excites the phosphorus at a given point in the image, and film projectors because the film is drawn forward mechanically, and thus must close a closing mechanism between each image square that is shown.

Measurements of light and colour are based on capturing a quantity of light over a given period of time, in order then to measure total light energy, or an approximation of total light energy in the time interval. To carry out a measurement that is as close as possible to what the eye will perceive, long measuring periods and/or sensors with long response time are often used.

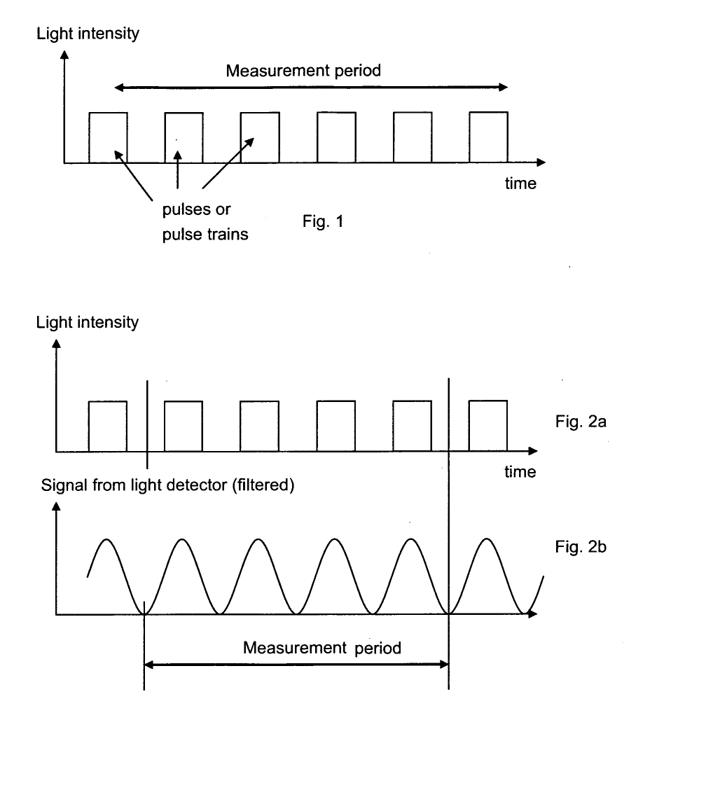

As schematically indicated in attached FIG. 1, the measurement, depending on when the starting and stopping times of the measurement occur, will be able to include a fraction of a full modulation cycle at “each end” of the measuring period or at only one end. Depending on how the modulation is determined, at worse a whole pulse more or less than desired will be measured, or the measurement will also contain a fraction of a pulse. This results in an inaccuracy of measurement that is not desirable.

The hitherto known solution to this problem has been to use long measuring intervals, which reduces the effect of this measuring inaccuracy. The measurement of N pulses may still give a deviation of +/−1 pulse, and a relative inaccuracy of +/−1/N.

For typical instruments, and a modulation frequency of 60 Hz, an accuracy of about +/− 1/300 of the total light quantity is obtained in a measuring period of 5 seconds.

When calibrating display equipment, it is desired to make necessary corrections of the display device, or of the image content supplied to the display device, such that an optimally colour accurate image is the result. In some applications, it is desired to ensure that the individual display device or projector reproduces a reference colour scale in the right way, whilst in other applications it is desirable first and foremost to obtain parity between different display devices in an overlapping area or overlapping edge area on the screen.

In a calibration process it is therefore necessary to carry out a number of measurements of different light and colour levels in order to be able to characterise the display device's response to different supplied stimuli (signals/images) and, after a possible adjustment, to be able to verify the result. The number of different measurements taken to be able to characterise, calibrate and verify a system will vary depending on the required precision, and depending on the time available for implementing the calibration. If each individual measurement can be made faster, the precision of the total calibration can be increased, or optionally the same calibration can be carried out over a shorter time, thereby reducing the maintenance time for a display device system in operation.

Most available systems for colour measurement are dependent on a stimulus (test image with colour information that is to be measured) being applied to the projector. The measurement then commences and when it is finished, the stimulus can be removed or changed for the next measurement. Synchronisation of these events is difficult because several sub-systems (image generator, projector, sensor, data acquisition equipment) must be controlled properly in time to obtain correct measurements. In practice, the process has either been made partly manual, or safety margins of up to several seconds per measurement have been included to ensure that the right stimulus is applied.

Therefore, an object of the present invention is to remedy the said hitherto existing problems and defects of the known systems, and to provide an improved method and device for measuring at least one of light intensity and colour in at least one modulated image.

This, and other objects that will be apparent from the following description, is achieved by a method and device according to the appended independent claims. Embodiments are set forth in the appended dependent claims.

According to an aspect of the present invention, there is provided a method for measuring at least one of light intensity and colour in at least one modulated image, the method comprising the steps of: a) detecting a modulation pattern of the modulated image(s); and b) synchronizing a measurement of the intensity and/or colour with the detected modulation pattern.

‘modulated image’ means here that there is a time variable modulation (e.g. through pulse width modulation) in the image due to the construction and associated operation of the apparatus providing the image, for instance a projector with a colour wheel, and not any modulation caused by particular images or image signals. The modulation of the at least one modulated image should be effected at a frequency that is sufficiently high to ensure that the human eye barely perceives the modulation, but instead perceives continuous light and colour.

By synchronizing the measurement with the detected modulation pattern (e.g. the modulation frequency), only complete pulses or pulse trains of light in the image(s) may be measured, which in turn results in a more accurate measure(ment) of intensity and/or colour.

Step a) may include detecting light pulses or pulse trains in the modulated image(s). Further, step b) may include at least one of starting the measurement between two detected consecutive pulses or pulse trains, and stopping the measurement between two detected consecutive pulses or pulse trains (wherein at least one of the latter pulses or pulse trains is different than the former, so that at least one complete pulse or pulse train can be measured). Alternatively or complementary, step b) may include starting/stopping the measurement at respective minima in the detected modulation pattern. A minimum in the detected modulation pattern may for instance be a time or instance when the detected intensity is zero or almost zero. A ‘measurement period’ may be defined as the time/period between start and end of the measurement.

The at least one modulated image may be provided by a projector. The projector may for instance be a DLP (video) projector. Alternatively, the at least one modulated image may be provided by some other display device, such as an LCD or plasma screen.

Further, step a) and the measurement may be performed by using at least one sensor arranged to receive light from the modulated image(s). The at least one sensor may for instance be arranged in or near a projection screen on which the at least one modulated image is projected by means of a projector. The at least one sensor may include a first more rapid sensor for detecting the modulation pattern, and a second more accurate sensor for measuring the intensity and/or colour.

The present method may further comprise introducing a particular start event in the modulated image(s); and start reading a sensor after a delay period following the particular start event for starting said measurement. By introducing the particular start event, and initiate reading off the sensor some time after the start event, a settling time of the sensor may be accounted for, and the measurement hence become more accurate. The particular start event may for instance be a particular start pulse or sequence or frame in the modulated image(s), such as one frame with high intensity followed by one image frame with low or zero intensity. Further, the sensor may be the above mentioned second sensor, while the particular start event may be detected by the above mentioned first sensor. The modulation pattern may be considered as discussed above, so that the reading off the sensor (i.e. the measurement) does not start/end on a light pulse or in a pulse train.

According to another aspect of the present invention, there is provided a device for measuring at least one of light intensity and colour in at least one modulated image, wherein the device comprises at least one sensor for receiving light from the modulated image(s) and configured to: detect a modulation pattern of the modulated image(s); and measure the intensity and/or colour in synchronization with the detected modulation pattern. This aspect of the invention may exhibit similar features and/or technical effects as the previously discussed aspect, and vice versa.

The at least one sensor may include a first (more rapid) sensor for detecting the modulation pattern, and a second (more accurate) sensor for measuring the intensity and/or colour.

The present method and device may for instance be used in sensor-based calibration when displaying or projecting images, in particular correction of light intensity and/or colour in images from a projector.

The invention will now be described in the form of an example with reference to the appended drawing figures.

FIG. 1 shows a known measuring method for measuring light and colour.

FIGS. 2a and 2b show the measuring method according to the invention.

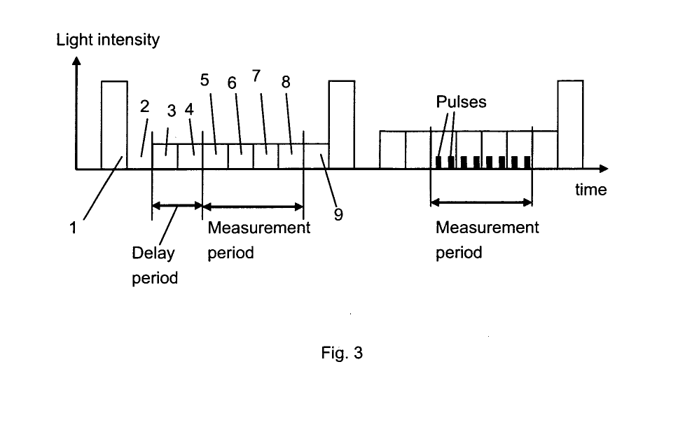

FIG. 3 illustrates measurement of a sequence of several colours in succession.

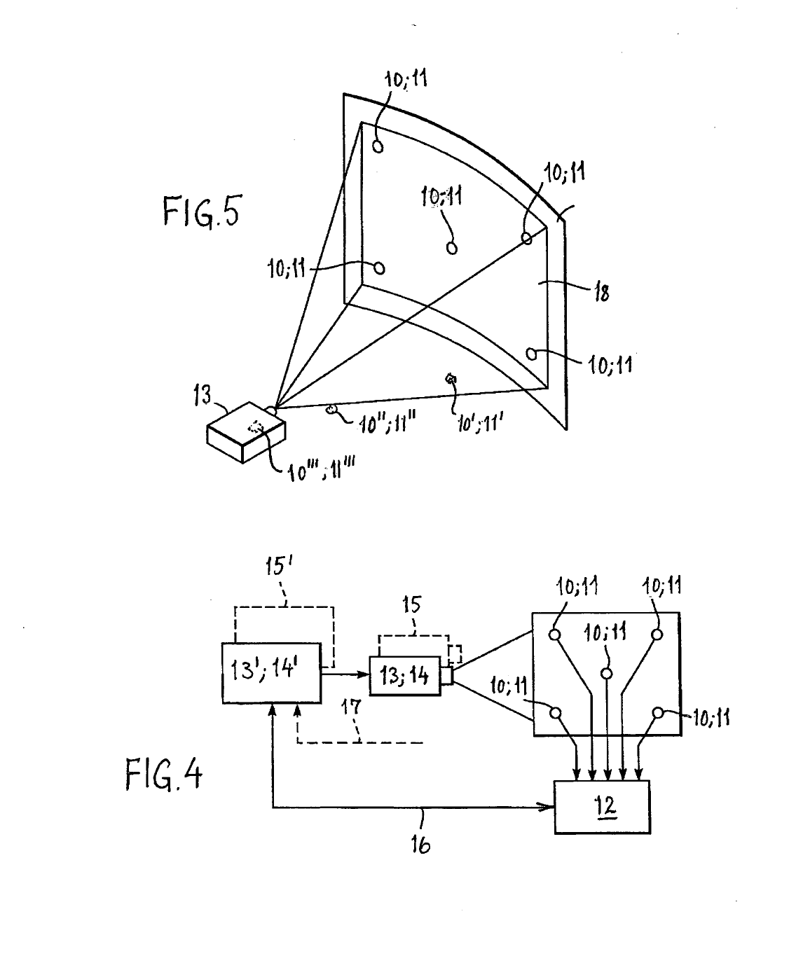

FIG. 4 shows schematically the connection of sensors to a processor for communication with a light and/or colour adjusting means or means.

FIG. 5 shows the projection of an image towards a screen where multiple sets of sensors are located.

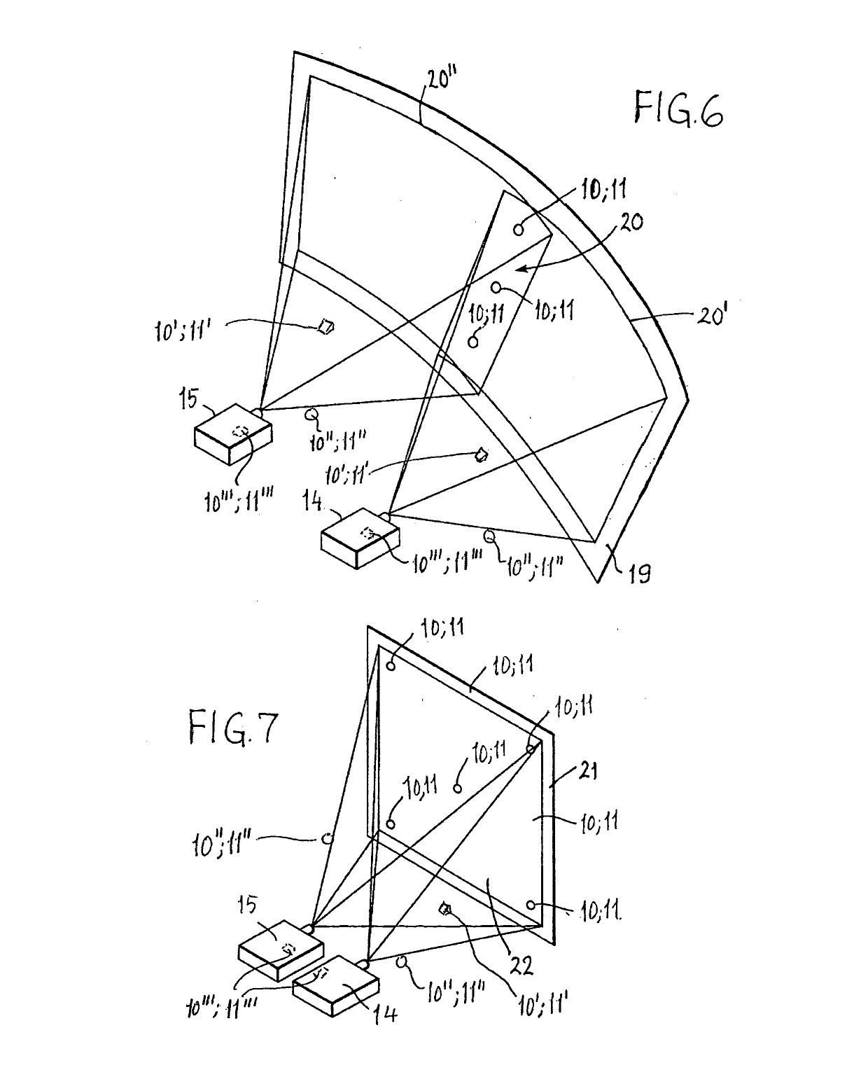

FIGS. 6 and 7 show the projection of images towards a common screen, where there are sensors in an overlapping area of the projected images which is partial or complete/almost complete, respectively.

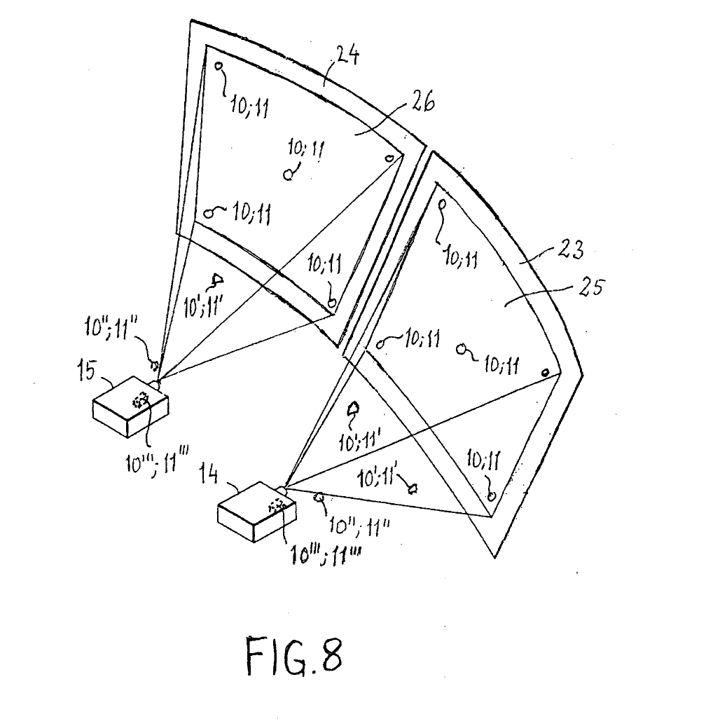

FIG. 8 shows projection towards two or more separate adjacent screens.

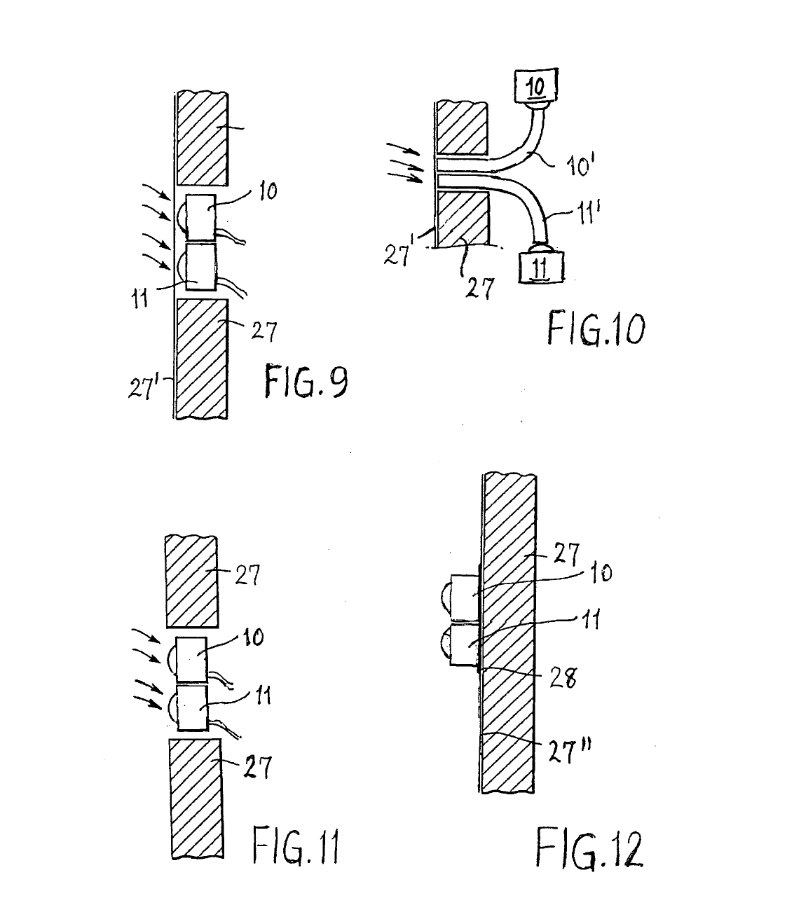

FIGS. 9 and 10 show how the sensors may be arranged under the surface of a projection screen.

FIG. 11 shows how sensors may be arranged in the screen itself; and

FIG. 12 shows how sensors may be arranged on the front face or the surface of the screen.

To avoid the said measuring inaccuracy, and to be able to make the measuring periods as short as possible, it is proposed, according to the invention, to allow the light measurement to be synchronised with the modulation frequency. It will thus also be possible to measure the energy in one or more pulses so as to be able to make the measuring time considerably shorter.

In this connection it is of importance that the measurement starts at the right time. This may, for example, be done in that the inherent modulation of the generated image allows a starting time to be found, or that a specific start event is introduced into the image signal supplied to the image projector(s), thereby enabling a sensor to capture such an event and determine measurement starting and stopping times.

The synchronisation is effected by combining two sensors with different properties:

1. A fast light detector 10 (see for instance FIG. 4) used to measure the variations in light within the modulation periods, to detect where modulation starts and stops.

2. A precise light and/or colour meter 11 used to read off the light energy, and where the measurement starting and stopping time can be controlled.

Both sensors are adapted so as to receive light from parts of, or the whole of the light emitter/projector image, either in that they are fed via a split light conductor or beam splitter, or in that they are placed sufficiently close to each other to receive light that represents approximately the same image.

Within this concept, it is also conceivable there may be one single sensor which has both of the said different properties. This is thus a technical equivalent.

The fast light detector will return a measuring signal which follows the modulation in the incident light, the light detector having a sufficiently fast response to allow time and/or phase information from the modulation to be derived. Deriving this information can, e.g., be done by finding local minimum values/maximum values in the signal and determining the time for such minima or maxima. Alternatively, the signal can be filtered so that only the characteristic modulation frequency (typically 60 Hz) is produced, and then phase information in the filtered signal is used to determine suitable times for beginning of measurement and end of measurement.

As the illustration in FIGS. 2a and 2b shows, the use of a filtered signal from the fast light detector will allow the beginning and the ending of measurement at times when the light source gives the lowest light intensity. It is thereby ensured that a whole number of modulation periods or pulses are measured. At a first minimum in the filtered signal from the fast light detector 10, a measurement is started with the slower precise light and/or colour meter 11. After a selected number of periods or pulses, this measurement is ended.

By also estimating the total measurement period through a time measurement between the two selected minima, a more precise determination of the modulation period length is also obtained, it thus being possible to determine precisely light energy per time unit, which is proportional to light flux into the sensor.

If a rapid sequence of measurements of different colours and/or signals is to be made, the time the slow light and/or colour meter needs to adapt to a new measuring signal, so-called settling time, may also be taken into account. It is conceivable to characterise a display device or projector by, e.g., running measurements at different points on a colour scale of grey tones and/or colour tones, where each grey tone and/or colour tone is passed to the sensor in a time interval, and a measurement is made in this interval.

If the colour meter requires a certain settling time, each individual measurement must be made in several steps:

i) Input desired measuring signal (including a particular start event) into the sensor.

ii) Wait for settling procedure of the slow light and/or colour sensor (delay period).

iii) Find a suitable starting point for the measurement (reading off the meter 11).

iv) Carry out the measurement until a suitable stopping point.

To carry out optimal measurement of a sequence of several colours in succession, e.g., by measuring a grey tone scale or a scale of primary colours, the colours can be separated by introducing synchronisation information or a particular start event into the signal that is measured, as indicated in FIG. 3.

FIG. 3 shows two successive measurements of different signals, where the particular start event is an image frame of high intensity 1, followed by an image frame 2 of low or zero intensity.

This requires the image source to be fed with a signal that can be varied from frame to frame. FIG. 3 thus indicates a synchronisation sequence that consists of the two image frames 1, 2 followed by a test signal for measuring (constant image) in image frames 3-9. True synchronisation time and measuring time must be determined on the basis of the settling time of the light/colour meter and required measuring times, which may be assumed to be a plurality of image frame periods.

Frames 1-9 to the left in FIG. 3 are shown without modulation, but each image frame may include one or more light pulses or light pulse trains, as indicated for some frames to the right in FIG. 3.

From the signal from the fast light detector 10, it is possible to find the synchronisation time by recognising the particular start event. This may, e.g., be done by detecting the transition from high to low intensity, as in the illustrated example in FIG. 3. The time for this transition is subsequently used to determine the measurement starting time and its stopping time. FIG. 3 indicates about two image frames 3, 4 for settling time (delay period), followed by a measuring period of four image frames 5-8 during which the meter 11 is read off, and then one image frame 9 that is a safety margin for the next synchronisation sequence.

In the example shown in FIG. 3, which is by no means limiting for the invention, it is thus possible to carry out a precise light and/or colour measurement for every ninth image frame, which is a dramatic improvement on existing colour and light measuring principles.

Thus, through synchronised use of two sensors to synchronise light and/or colour measurements, the invention thus makes it possible to increase measuring precision and/or reduce measuring time substantially. Moreover, the use of synchronisation information (particular start event) integrated in the signal provides a better degree of certainty that the measuring period is placed at the right time, that is to say, by starting the measuring when the test image is stable and in addition that the sensor has settled to measure the test colour.

This means, inter alia, that in addition to using two sensors 10 and 11, or optionally one sensor which has the properties of each of the two sensors, it should be ensured that the measurements are deliberately started between the light and/or colour pulse (trains), or that the measurements are started before or after the pulse (trains), but never in the pulse (train) itself.

The present invention thus permits shorter, more precise measurement periods, whether subsequently used for calibration or adjustment of a single projector or simpler co-calibration of a plurality of projectors which project an image towards a common screen, and in addition more correct colours generally can be obtained.

FIG. 4 shows schematically how a first sensor 10 and a second sensor 11 can be connected to a processor 12 for communication with a light and/or colour adjusting means or means 13′; 14′; 15′ in or associated with one projector/display device 13 or in associated at least two projectors/display devices 14, 15. The connection between the processor 12 and said means 12′; 14′; and 15′ take place via data paths 16 and 17. The first sensor 10, which is a light flux sensor, preferably has a very short response time, whilst the second sensor 11, which is a light and/or colour sensor, may have a slightly longer response time or settling time after triggering. However, it is conceivable that both sensors are of a fast type, i.e., with very short settling time, so that the settling period may be shortened and measuring may be carried out, for example, at closer intervals than each ninth image frame. In such a case, it is also conceivable that the two sensors are constituted by a single combined sensor which has a very rapid settling time.

FIG. 5 shows how one single projector 13 can project images towards a screen 18 where multiple sets of sensors 10, 11 are located such that relevant image information can easily be captured. The positioning of the sensors may be selected based on at least one of the following options: on the surface of the screen, in the screen, under the front surface of the screen, in or close to the edge area of the image on the screen, in an image frame, and in a frame for the screen. Although here positioning is envisaged in connection with the screen, it is within the scope of the invention that it is also possible to position one or more sensors at a randomly selected, but functional location where it is possible to capture light or a fraction of light from the projector. As a non-limiting example in this respect, there is envisaged, for example, sensor capture of reflected light from the screen, where sensor 10′; 11′ is positioned at an expedient, but random location in the space in front of the screen. As another non-limiting example, it is conceivable to place such a sensor 10″; 11″ respectively, 10′″; 11′″ close to or in the actual optics in the projector, thereby allowing light to be picked up in the optical path in or just outside the projector.

FIG. 6 shows how two projectors 14, 15 can project images towards a common screen 19 where multiple sets of sensors 10, 11 are located in an overlapping area 20 for the projected images 20′; 20″. Other or supplementary positions of the sensors are also conceivable based on at least one of the following options: in cooperation with the screen, for example, where this does not display overlapping images, in or close to edge areas of the images on the screen, in an image frame on the images, and in a frame for the screen. Although here positioning is envisaged in connection with the screen, it is within the scope of the invention also possible to position one or more of the sensors at a randomly selected, but functional location where it is possible to capture light or a fraction of light from the projector. As a non-limiting example in this respect, there is, for example, envisaged sensor capture of reflected light from screens, where sensor 10′ 11′ is positioned at an expedient, but per se random location in the space in front of the screen. As another non-limiting example, it is conceivable to locate such a sensor 10″; 11″ respectively 10′″; 11′″ close to or in the actual optics in one of or both projectors, thereby allowing light to be picked up in the optical path in or just outside such a projector.

FIG. 7 shows how two projectors 14, 15 can project images towards a common screen 21 where multiple sets of sensors 10, 11 are found in an overlapping area 22 for the projected images which in the illustrated example are intended to be 100% or almost completely overlapping. It is also possible to conceive of other or supplementary positions of the sensors based on at least one of the following options: in cooperation with the screen where this does not display overlapping images, in or close to edge areas of the images on the screen, in an image frame on the images, and in a frame for the screen. Although here positioning is envisaged in connection with the screen, it is within the scope of the invention also possible to position one or more sensors at a randomly selected, but functional location where it is possible to capture light or a fraction of light from the projectors. As a non-limiting example in this respect there is envisaged, for example, sensor capture of reflected light from the screen, where sensor 10′; 11′ is positioned at an expedient, but per se random location in the space in front of the screen. As another non-limiting example, it is conceivable to locate such a sensor 10″; 11″ respectively 10′″; 11′″ close to or in the actual optics in one of both projectors, thereby allowing light to be collected in the optical path in or just outside such a projector.

In connection with the embodiments shown in FIGS. 6 and 7, it should be pointed out that it will be essential to allow the respective projectors 14, 15 to be connected to respective sensor or respective sets of sensors.

A further example of use can be seen from FIG. 8 which shows two separate, juxtaposed screens, although it is conceivable to have, for example, three or more separate juxtaposed screens and where images are projected from respective projectors. In this case, the projectors 14; 15 will project images 25; 26 towards the respective screen 23; 24 where multiple sets of sensors 10, 11 are located such that they easily can capture relevant image information. The positioning of the sensors may be selected based on at least one of the following options: on the surface of the screen, in the screen, under the front surface of the screen, in or close to an edge area of the image on the screen, in an image frame, and in a frame for the screen. Although here positioning is envisaged in connection with the screen, it is within the scope of the invention also possible to position one or more sensors at a randomly selected, but functional location where it is possible to capture light or a fraction of light from one of or both projectors. As a non-limiting example in this respect, there is envisaged, for example, sensor capture of reflected light from the screen, where sensor 10′; 11′ is positioned at an expedient, but per se random location in the space in front of the screen. As another non-limiting example it is conceivable to locate such sensor 10″; 11″ or 10′″; 11′″ close to or in the actual optics of the projector, thereby allowing light to be picked up in the optical path in or just outside the projector. Here, it will understood how important it is to harmonise the quality, light and colour shades in the images shown on the separate screens, such that the visual perception of the images will at all times be optimal.

When using the method and device according to the invention, said at least one sensor device 10; 11; 10′; 11′; 10″; 11″; 10′″; 11′″ will be positioned such that said correction of light and/or colours from said one or more projectors takes place in connection with the projection of at least one of:
image on one screen;
images provided adjacent to each other on one common screen;
images on separate respective screens;
images which have an overlapping area on a common screen;
overlapping area of images produced on a common screen; and
an image portion of one of at least two images in an overlapping area on a common screen.

FIG. 9 shows how the sensors 10, 11 can be placed under the surface 27′ of a screen 27. The surface 27′ here may, for example, be a transparent canvas, a transparent film, a transparent layer of paint, or transparent plate or the like.

FIG. 10 shows how the sensors 10, 11 can be placed under the surface 27′ of a screen 27 in that light is conducted from the underside of the surface 27′ to the sensors 10; 11 via respective light conductors 10′; 11′. The surface 27′ here may, for example, be a transparent canvas, a transparent film, a transparent coating of paint, a transparent plate or the like.

FIG. 11 shows how the sensors 10; 11 can be placed in the screen 23 itself, and FIG. 12 shows how the sensors can be located on the front face or surface 27″ of the screen 27, for example by means of an adhesive 28.

The solution shown in FIG. 10 makes it possible to reduce the area of the measuring point such that it will be on the screen.

Where the two sensors 10, 11 can be replaced by, for example, one single sensor, for example, sensor 11 if it is sufficiently fast, it will be understood that the sensor detection area at the measuring point itself and as shown in FIGS. 9-12 could be halved.

The person skilled in the art will realize that the present invention by no means is limited to the embodiment(s) described above. On the contrary, many modifications and variations are possible within the scope of the appended claims.

It is further envisaged a method (and corresponding device) for measuring at least one of light intensity and colour in at least one (modulated) image, the method comprising the steps of: introducing a particular start event in the (modulated) image(s); and start reading a sensor after a delay period following the particular start event for measuring the light intensity and/or colour. (FIG. 3)

1. A method for measuring at least one of light intensity and colour in at least one modulated image, the method comprising:
a) detecting a modulation frequency of the modulated image(s); and
b) synchronizing a measurement of the intensity and/or colour with the detected modulation frequency.

2. A method according to claim 1, wherein a) comprises detecting light pulses or pulse trains in the modulated image(s).

3. A method according to claim 2, wherein b) comprises at least one of starting the measurement between two detected consecutive pulses or pulse trains, and stopping the measurement between two detected consecutive pulses or pulse trains.

4. A method according to claim 1, wherein b) comprises at least one of starting the measurement at a minimum in a detected modulation pattern, and stopping the measurement at another minimum in the detected modulation pattern.

5. A method according to claim 1, wherein the at least one modulated image is provided by a projector.

6. A method according to claim 1, wherein a) and the measurement is performed by using at least one sensor arranged to receive light from the modulated image(s).

7. A method according to claim 1, further comprising:
introducing a particular start event in the modulated image(s); and
starting reading a sensor after a delay period following the particular start event for starting said measurement.

8. A device for measuring at least one of light intensity and colour in at least one modulated image, the device comprising at least one sensor for receiving light from the modulated image(s), wherein the at least one sensor is configured to:
detect a modulation frequency of the modulated image(s); and
measure the intensity and/or colour in synchronization with the detected modulation frequency.

9. A device according to claim 8, wherein the at least one sensor comprises a first sensor for detecting the modulation frequency, and a second sensor for measuring the intensity and/or colour.
